(19) United States
(12) Patent Application Publication
(10) Pub. No.: US 2022/0292351 A1
(43) Pub. Date: Sep. 15, 2022

(54) SYSTEMS, METHODS, AND STORAGE MEDIA FOR GENERATING SYNTHESIZED DEPTH DATA

(71) Applicant: IRDETO B.V., Hoofddorp (NL)

(72) Inventors: Ali ETEMAD, Kanata (CA); Alireza SEPAS-MOGHADDAM, Kingston (CA); Hardik UPPAL, Vancouver (CA); Michael GREENSPAN, Kingston (CA); Martin SOUKUP, Hoofddorp (NL)

(73) Assignee: IRDETO B.V., Hoofddorp (NL)

(21) Appl. No.: 17/690,173

(22) Filed: Mar. 9, 2022

(30) Foreign Application Priority Data
Mar. 15, 2021 (EP) 21162660.1

(51) Int. Cl. G06N 3/08; G06N 3/04; G06T 3/40

(52) U.S. Cl. CPC G06N 3/08; G06N 3/0481; G06N 3/0454; G06T 3/4038

(57) ABSTRACT

Disclosed implementations include a depth generation method using a novel teacher-student GAN architecture (TS-GAN) to generate depth images for 2-D images, such as RGB images, where no corresponding depth information is available. An example model consists of two components, a teacher and a student. The teacher consists of a fully convolutional encoder-decoder network as a generator along with a fully convolution classification network as the discriminator. The generator takes 2-D images as inputs and aims to output the corresponding depth images. The teacher learns an initial latent mapping between 2-dimensional and co-registered depth images and the student applies the latent mapping to provide feedback to the classification network for refinement.

### FIELD OF THE DISCLOSURE

The present disclosure relates to systems, methods, and storage media for generating synthesized depth data based on 2-dimensional data to enhance the 2-dimensional for image recognition and other purposes.

### BACKGROUND

Facial recognition is an active research area, which has recently witnessed considerable progress thanks to the availability of known deep neural networks such as AlexNet, VGG, FaceNet, and ResNet. A “neural network” (sometimes referred to as an “artificial neural network”), as used herein, refers to a network or circuit of neurons which can be implemented as computer-readable code executed on one or more computer processers. A neural network can be composed of artificial neurons or nodes for solving artificial intelligence (AI) problems. The connections of the nodes are modeled as weights. A positive weight reflects an excitatory connection, while negative values mean inhibitory connections. Inputs can be modified by a weight and summed. This activity is referred to as a linear combination. Finally, an activation function controls the amplitude of the output. For example, an acceptable range of output is usually between 0 and 1, or it could be —1 and 1. Neural networks may be used for predictive modeling, adaptive control and applications where they can be trained via a dataset. Self-learning resulting from experience can occur within networks, which can derive conclusions from a complex and seemingly unrelated set of information. Deep neural networks can learn discriminative representations that have been able to tackle wide range of challenging visual tasks, such as image recognition, and even surpass human recognition ability in some instances.

2-dimensional based image recognition methods, such as facial recognition methods, tend to be generally sensitive to environmental variations like illumination, occlusions, viewing angles and poses. By utilizing depth information alongside 2-dimensional image data, such as RGB data, models can learn more robust representations of faces and other objects, as depth provides complementary geometric information about the intrinsic shape of the face, further boosting recognition performance. Additionally, RGB and Depth (RGB-D) facial recognition methods are known to be less sensitive to pose and illumination changes. Nonetheless, while RGB and other 2-dimensional sensors are ubiquitous, depth sensors have been less prevalent, resulting in an over-reliance on 2-dimensional data alone.

Generative Adversarial Networks (GANs) and variants thereof (e.g., cGan, pix2pix, CycleGan, StackGAN, and StyleGAN) have proven to be viable solutions for data synthesis in many application domains. In the context of facial images, GANs have been widely used to generate very high-quality RGB images when trained on large-scale datasets such as FFHQ and CelebA-HQ. In a few instances, is has been attempted to synthesize depth from corresponding RGB images. For example, Stefano Pini, Filippo Grazioli, Guido Borghi, Roberto Vezzani, and Rita Cucchiara, Learning to generate facial depth maps, 2018 International Conference on 3D Vision (3DV), pages 634-642. IEEE, 2018; Dong-hoon Kwak and Seung-ho Lee, A novel method for estimating monocular depth using cycle gan and segmentation, Sensors, 20(9):2567, 2020; and Jiyun Cui, Hao Zhang, Hu Han, Shiguang Shan, and Xilin Chen, Improving 2D face recognition via discriminative face depth estimation. In International Conference on Biometrics, pages 140-147, 2018 teach various methods for synthesizing depth data from 2-dimensional data.

Although cGAN has achieved impressive results for depth synthesis using paired RGB-D sets, it does not easily generalize to new test examples for which paired examples are not available, especially when the images are from entirely different datasets with drastically different poses, expressions, and occlusions. CycleGAN attempts to overcome this shortcoming through unpaired training with the aim of generalizing well to new test examples. However, CycleGAN does not deal well with translating geometric shapes and features.

The majority of existing work in this area relies on classical non-deep techniques. Sun et al. (Zhan-Li Sun and Kin-Man Lam. Depth estimation of face images based on the constrained ica model, IEEE transactions on information forensics and security, 6(2):360-370, 2011) teaches the use of images of different 2-dimensional face poses to create a 3D model. This was achieved by calculating the rotation and translation parameters with constrained independent component analysis and combining it with a prior 3D model for depth estimation of specific feature points. In a subsequent work (Zhan-Li Sun, Kin-Man Lam, and Qing-Wei Gao. Depth estimation of face images using the nonlinear least-squares model, IEEE transactions on image processing, 22(1):17-30, 2012) a nonlinear least-squares model was exploited to predict the depth of specific facial feature points, and thereby inferring the 3-dimensional structure of the human face. Both these methods used facial landmarks obtained by detectors for parameter initialization making them highly dependent on landmark detection.

Liu et al. (Miaomiao Liu, Mathieu Salzmann, and Xuming He, Discrete-continuous depth estimation from a single image, Proceedings of the IEEE Conference on Computer Vision and Pattern Recognition, pages 716-723, 2014) modelled image regions as superpixels and used discrete-continuous optimization for depth estimation. In this context, the continuous variables encoded the depth of the superpixel while the discrete variables represented their internal relationships. In a later work, Zhu et al. (Wei Zhuo, Mathieu Salzmann, Xuming He, and Miaomiao Liu, Indoor scene structure analysis for single image depth estimation, Proceedings of the IEEE conference on computer vision and pattern recognition, pages 614-622, 2015) exploited the global structure of the scene, by constructing a hierarchical representation of local, mid-level, and large-scale layouts. They modeled the problem as conditional Markov random field with variables for each layer in the hierarchy. Kong et al. (Dezhi Kong, Yang Yang, Yun-Xia Liu, Min Li, and Hongying Jia, Effective 3d face depth estimation from a single 2d face image, 2016 16th International Symposium on Communications and Information Technologies (ISCIT), pages 221-230. IEEE, 2016) mapped a 3D dataset to 2D images by sampling points from the dense 3D data and combining it with RGB channel information. They then exploited face Delaunay triangulation to create a structure of facial feature points. The similarity of the triangles among the test images and the training set allowed them to estimate depth.

There have been attempts at synthesizing depth data using deep learning architectures. Cui et al. (Jiyun Cui, Hao Zhang, Hu Han, Shiguang Shan, and Xilin Chen, Improving 2D face recognition via discriminative face depth estimation, International Conference on Biometrics, pages 140-147, 2018) teaches estimating depth from RGB data using a multi-task approach consisting of face identification along with depth estimation. This reference also discloses RGB-D recognition experiments to study the effectiveness of the estimated depth for the recognition task. Pini et al. (Florian Schroff, Dmitry Kalenichenko, and James Philbin, Facenet: A unified embedding for face recognition and clustering, Proceedings of the IEEE conference on computer vision and pattern recognition, pages 815-823, 2015) teaches using a cGAN architecture for facial depth map estimation from monocular intensity images. The method uses co-registered intensity and depth images to train the generator and learn relationships between the images for use in face verification.

Kwak et al. (Dong-hoon Kwak and Seung-ho Lee, A novel method for estimating monocular depth using cycle gan and segmentation, Sensors, 20(9):2567, 2020) proposes a solution based on CycleGAN for generating depth and image segmentation maps. To estimate the depth information, the image information is transformed to depth information while maintaining the characteristics of the RGB image, owing to the consistency loss of CycleGAN. This reference also teaches adding the consistency loss of segmentation to generate depth information where it is ambiguous or hidden by larger features of RGB image.

Early RGB-D facial recognition methods were proposed based on classical (non-deep) methods. Goswami et al. (Gaurav Goswami, Samarth Bharadwaj, Mayank Vatsa, and Richa Singh. On RGB-D face recognition using Kinect, International Conference on Biometrics: Theory, Applications and Systems, pages 1-6. IEEE, 2013) teaches fusing visual saliency and entropy maps extracted from RGB and depth data. This reference further teaches that histograms of oriented gradients can be used to extract features from image patches to then feed a classifier for identity recognition. Li et al. (Billy Y L Li, Ajmal S Mian, Wanquan Liu, and Aneesh Krishna, Face recognition based on Kinect. Pattern Analysis and Applications, 19(4):977-987, 2016) teaches using 3D point-cloud data to obtain a pose-corrected frontal view using a discriminant color space transformation. This reference further teaches that corrected texture and depth maps can be sparse approximated using separate dictionaries earned during the training phase.

More recent efforts have focused on deep neural networks for RGB-D facial recognition. Chowdhury et al. (Anurag Chowdhury, Soumyadeep Ghosh, Richa Singh, and Mayank Vatsa, RGB-D face recognition via learning-based reconstruction, International Conference on Biometrics Theory, Applications and Systems, pages 1-7, 2016) teaches the use of Auto-Encoders (AE) to learn a mapping function between RGB data and depth data. The mapping function can then be used to reconstruct depth images from the corresponding RGB to be used for identification. Zhang et al. (Hao Zhang, Hu Han, Jiyun Cui, Shiguang Shan, and Xilin Chen, RGB-D face recognition via deep complementary and common feature learning, IEEE International Conference on Automatic Face & Gesture Recognition, pages 8-15, 2018) addressed the problem of multi-modal recognition using deep learning, focusing on joint learning of the CNN embedding to fuse the common and complementary information offered by the RGB and depth data together effectively.

Jiang et al. (Luo Jiang, Juyong Zhang, and Bailin Deng, Robust RGB-D face recognition using attribute-aware loss, IEEE Transactions on Pattern Analysis and Machine Intelligence, 42(10):2552-2566, 2020) proposes an attribute-aware loss function for CNN-based facial recognition which aimed to regularize the distribution of learned representations with respect to soft biometric attributes such as gender, ethnicity, and age, thus boosting recognition results. Lin et al. (Tzu-Ying Lin, Ching-Te Chiu, and Ching-Tung Tang, RGBD based multi-modal deep learning for face identification, IEEE International Conference on Acoustics, Speech and Signal Processing, pages 1668-1672, 2020) teaches an RGB-D face identification method by introducing new loss functions, including associative and discriminative losses, which are then combined with softmax loss for training.

Uppal et al. (Hardik Uppal, Alireza Sepas-Moghaddam, Michael Greenspan, and Ali Etemad, Depth as attention for face representation learning, International Conference of Pattern Recognition, 2020) teaches a two-level attention module to fuse RGB and depth modalities. The first attention layer selectively focuses on the fused feature maps obtained by a convolutional feature extractor that were recurrent learned through an LSTM layer. The second attention layer then focused on the spatial features of those maps by applying attention weights using a convolution layer. Uppal et al. also teaches that the features of depth images can be used to focus on regions of the face in the RGB images that contained more prominent person-specific information.

### SUMMARY

Disclosed implementations include a depth generation method using a novel teacher-student GAN architecture (TS-GAN) to generate depth images for 2-dimensional images, and thereby enhance the 2-dimensional data, where no corresponding depth information is available. An example model consists of two components, a teacher and a student. The teacher consists of a fully convolutional encoder-decoder network as a generator along with a fully convolution classification network as the discriminator. The generator part of a GAN learns to create data by incorporating feedback from a discriminator. It learns to make the discriminator classify its output as real. The discriminator in a GAN is simply a classifier. It distinguishes real data from the data created by the generator. A discriminator can use any network architecture appropriate to the type of data it's classifying. In the disclosed implementations, the generator takes RGB images as inputs and aims to output the corresponding depth images. In essence, the teacher aims to learn an initial latent mapping between RGB and co-registered depth images.

The student itself consists of two generators in the form of encoder-decoders, one of which is “shared” with the teacher, along with a fully convolutional discriminator. The term “shared”, as used herein to describe the relationship between the generators, means that the generators operate using the same weightings. The generators can be a single instance or different instances of a generator. Further, the generators can be implemented on the same physical computing device or in distinct computing devices. The student takes as its input an RGB image for which the corresponding depth image is not available and maps it onto the depth domain as guided by the teacher to generate synthesized depth data (also referred to as “hallucinated” depth data herein). The student is operative to further refine the strict mapping learned by the teacher and allow for better generalization through a less constrained training scheme.

One aspect of the disclosed implementations is a method implemented by a neural network for determining mapping function weightings that are optimized for generating synthesized depth image data from 2-dimensional image data, the method comprising: receiving training data, the training data including multiple sets of 2-dimensional image data and corresponding co-registered depth image data; training a first generator, with the training data, to develop a set of mapping functions weightings for mapping between sets of 2-dimensional image data and corresponding co-registered depth image data; applying the mapping function weightings, by a second generator, to a first set of 2-dimensional image data, to thereby generate synthesized depth data corresponding to the set of 2-dimensional image data; processing the synthesized depth data, by an inverse generator, to transform the depth data to a second set of 2-dimensional image data; comparing the first set of 2-dimensional image data to the second set of 2-dimensional image data and generating an error signal based on the comparison; adjusting the set of mapping function weightings based on the error signal; and repeating the applying, processing comparing and adjusting steps until specified end criterion is satisfied.

Another aspect of the disclosed implementations is a computing system implementing a neural network for determining mapping function weightings that are optimized for generating synthesized depth image data from 2-dimensional image data, the system comprising: at least one hardware computer processor operative to execute computer-readable instructions; and at least one non-transient memory device storing computer executable instructions thereon, which when executed by the at least one hardware computer processor, cause the at least one hardware computer processor to conduct a method of: receiving training data, the training data including multiple sets of 2-dimensional image data and corresponding co-registered depth image data; training a first generator, with the training data, to develop a set of mapping functions weightings for mapping between sets of 2-dimensional image data and corresponding co-registered depth image data; applying the mapping function weightings, by a second generator, to a first set of 2-dimensional image data, to thereby generate synthesized depth data corresponding to the set of 2-dimensional image data; processing the synthesized depth data, by an inverse generator, to transform the depth data to a second set of 2-dimensional image data; comparing the first set of 2-dimensional image data to the second set of 2-dimensional image data and generating an error signal based on the comparison; adjusting the set of mapping function weightings based on the error signal; and repeating the applying, processing comparing and adjusting steps until specified end criterion is satisfied.

Another aspect of the disclosed implementations is non-transient computer-readable media having computer-readable instructions stored thereon which, when executed by a computer processor cause the computer processor to conduct a method implemented by a neural network for determining mapping function weightings that are optimized for generating synthesized depth image data from 2-dimensional image data, the method comprising: receiving training data, the training data including multiple sets of 2-dimensional image data and corresponding co-registered depth image data; training a first generator, with the training data, to develop a set of mapping functions weightings for mapping between sets of 2-dimensional image data and corresponding co-registered depth image data; applying the mapping function weightings, by a second generator, to a first set of 2-dimensional image data, to thereby generate synthesized depth data corresponding to the set of 2-dimensional image data; processing the synthesized depth data, by an inverse generator, to transform the depth data to a second set of 2-dimensional image data; comparing the first set of 2-dimensional image data to the second set of 2-dimensional image data and generating an error signal based on the comparison; adjusting the set of mapping function weightings based on the error signal; and repeating the applying, processing comparing and adjusting steps until specified end criterion is satisfied.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a schematic diagram of the two modes of the system and method in accordance with one or more implementations.

FIG. 2 is a schematic diagram of the Student Teacher Network in accordance with one or more implementations.

FIG. 3 is a flowchart of a method for determining mapping weightings in accordance with one or more implementations.

FIG. 4 illustrates depth generated by the alternative methods and a disclosed implementation.

FIG. 5 illustrates a t-SNE visualization of the embeddings generated from a ResNet-50 network for RGB images, ground truth depth images, and synthesized depth images generated by the disclosed implementations.

FIG. 6 illustrates synthesized depth generated by disclosed implementations based on various test data sets.

### DETAILED DESCRIPTION

Disclosed implementations include a novel teacher-student adversarial architecture which generates realistic depth images from a single 2-dimensional image, such as a 2-dimensional (RGB for example) image. A student architecture is used to refine the strict latent mapping between 2-dimensional and depth (D) domains learned by the teacher to obtain a more generalizable and less constrained relationship. The synthesized depth can be used to enhance the 2-dimensional data for RGB-D image recognition, such as facial recognition.

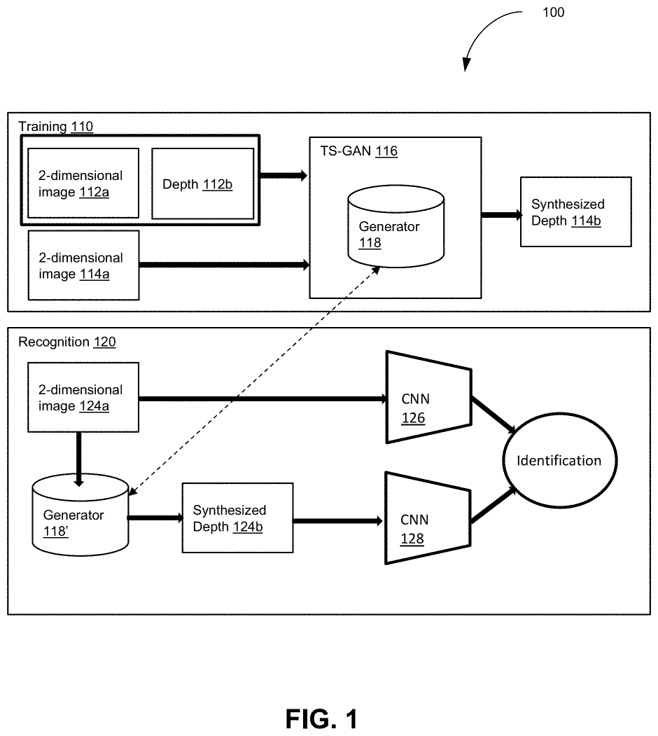

FIG. 1 illustrates the overall framework 100 of a disclosed implementation. In training phase 110, TS-GAN 116 is trained with training data including one or more sets of 2-dimensional image data 112a and corresponding depth data 112b to determine weightings to be used by generator 118 for generating synthesized depth data 114b in response to receipt of 2-dimensional image date 114a in a known manner. In recognition phase 120, 2-dimensional image data 124a is processed by generator 118′ to create synthesized depth data 124b. Convolutional Neural Network (CNN) 126 processes the 2-dimensional data 126 and CNN 128 processes the synthesized depth data 124b. The outputs of CNN 126 and CN 128 are fused and applied for identification. Significantly, the generators 118 and 118′ are “shared” between a teacher component and a student component as described below.

As noted above, disclosed implementations address the problem of depth generation for RGB images, p_{target}(Aᵣ), with no corresponding depth information, where we are provided RGB-D data which we refer to as a teacher dataset with Aₜ being RGB images and Bₜ being the corresponding co-registered depth images. The teacher dataset is used to learn a mapping generator function G_{A2B} that can accurately generate the depth images for target RGB images Aᵣ.

As noted above an architecture of TS-GAN, in accordance with disclosed implementations, consists of a teacher component and a student component (also referred to merely as “teacher” and “student” herein). The teacher learns a latent mapping between Aₜ and Bₜ. The student then refines the learned mapping for Aᵣ by further training the generator, with another generator-discriminator pair.

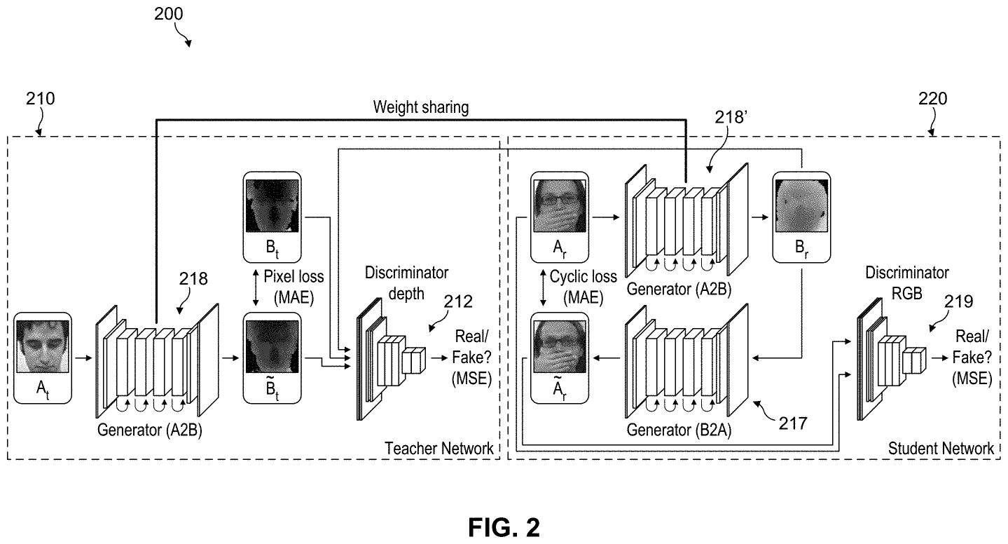

FIG. 2 schematically illustrates a TS-GAN system configuration in accordance with disclosed implementations. TS-GAN system 200 can be implemented by one or more computing devices executing “program modules”, i.e. executable code which performs a specified function when executed by a computer processor. System 200 includes teacher 210 and student 220. For the teacher we create a mapping function, G_{A2B}: Aₜ→Bₜ for generator 218 along with a discriminator 212 (D_{depth}). The loss for the mapping function ( [symbol] (G_{A2B})) is then formulated as:

$$ℒ ( {G}_{A 2 B} ) = \frac{1}{2} {𝔼}_{{A}_{t} ∼ {p}_{data} ( {A}_{t} )} [ ( {{D}_{depth} ( {G}_{A 2 B} ( {A}_{t} ) - 1 )}^{2} ] \qquad ( 1 )$$

where:

[symbol] _{A}, is a 2-dimensional image sampled from pₜᵣₐᵢₙ(Aₜ), which is the distribution of 2-dimensional images in the teacher dataset pₜᵣₐᵢₙ(Aₜ).

The loss for depth discriminator 212 ( [symbol] (D_{depth})) can be expressed as:

$$ℒ ( {D}_{depth} ) = \frac{1}{2} {𝔼}_{{B}_{t} ∼ {p}_{data} ( {B}_{t} )} [ {( {D}_{depth} ( {B}_{t} ) - 1 )}^{2} ] + \frac{1}{2} \text{?} [ ( {{D}_{depth} ( {G}_{A 2 B} ( {A}_{t} ) )}^{2} ] , \qquad ( 2 )$$

$$\text{?} \text{indicates text missing or illegible when filed}$$

where:

[symbol] _{B}_{ᵢ} represents a dep image sampled from pₜᵣₐᵢₙ(Aₜ), which is the distribution of depth images in the teacher dataset.

The additional Euclidean loss [symbol] ₚᵢₓₑₗ between the synthesized depth and ground truth depth can be expressed as:

$${ℒ}_{pixel} = ( \frac{1}{n} ) {\sum }_{i = 1}^{n} \vert {B}_{i} - {G}_{A 2 B} ( {A}_{t} ) \vert . \qquad ( 3 )$$

The student component aims to convert a single 2-dimensional image, Aᵣ, from the 2-dimensional dataset in which no depth information is available, to a target depth image, Bᵣ. This is done using the mapping function G_{A2B} (Eq. 1) of generator 218′ along with an inverse mapping function, G_{B2A}: Bᵣ→Aᵣ of generator 217, and a discriminator 219 (D_{RGB}). The loss for the mapping function ( [symbol] (G_{B2A})) and the discriminator ( [symbol] (D_{RGB})) is then

formulated as:

$$ℒ ( {G}_{B 2 A} ) = \frac{1}{2} {𝔼}_{{A}_{r} ∼ {p}_{target} ( {A}_{r} )} [ ( {{D}_{RGB} ( {G}_{B 2 A} ( {G}_{A 2 B} ( {A}_{r} ) ) - 1 )}^{2} ] , \qquad ( 4 )$$

Where: [symbol] Aᵣ represents a 2-dimensional image sampled from p_{target}(Aᵣ), which is the distribution of a 2-dimensional target data set.

The loss for discriminator 219 ( [symbol] (D_{RGB})) which discriminates between ground truth 2-dimensional images and the generated 2-dimensional image is:

$$ℒ ( {D}_{RGB} ) = \frac{1}{2} {𝔼}_{{A}_{r} ∼ {p}_{target} ( {A}_{r} )} [ {( {D}_{RGB} ( {A}_{r} ) - 1 )}^{2} ] + \frac{1}{2} {𝔼}_{{A}_{r} ∼ {p}_{target} ( {A}_{r} )} [ ( {{D}_{RGB} ( {G}_{B 2 A} ( {G}_{A 2 B} ( {A}_{r} ) ) )}^{2} ] . \qquad ( 5 )$$

Inverse generator 217, G_{B2A}, inverses the mapping from the synthesized depth back to 2-dimensional data. This is done to preserve the identity of the subject (in the example of the images being images of a person such as facial images) and provide additional supervision in a cyclic-consistent way. Accordingly, the cyclic consistency loss can be expressed as:

$${ℒ}_{cyc} = ( \frac{1}{n} ) {\sum }_{i = 1}^{n} \vert {A}_{r} - {G}_{A 2 B} ( {G}_{B 2 A} ( {A}_{r} ) ) \vert \qquad ( 6 )$$

The total loss for teacher 210 can be summarized as:

[symbol]

_{teach}= [symbol] (G_{A2B})+λₚᵢₓₑₗ· [symbol] ₚᵢₓₑₗ, (7)

where λₚᵢₓₑₗ is the weighting parameter for the pixel loss [symbol] ₚᵢₓₑₗ described in Equation 3 above.

The total loss for student 220, can be summarized as:

[symbol]

_{student}= [symbol] (G_{A2B})+ [symbol] (G_{B2A})+λ_{eye}· [symbol] _{eye}, (8)

where λ_{eye} is the weighting parameter for the cyclic loss [symbol] _{eye} described in Equation 6 above.

Pseudocode for an example algorithm of operation of system 200 is set forth below.

| Input : teacher dataset pₜᵣₐᵢₙ(Aₜ, Bₜ), target RGB | | |
|---|---|---|
| dataset p_{target}(Aᵣ), mapping generator function | | |
| G_{A2B} and G_{B2A}, discriminators D_{RGB} and | | |
| D_{Depth}, training configurations (loss weights: | | |
| λₚᵢₓₑₗ, λ_{eye}; learning rates: α_{teach}, α_{student}; total | | |
| epochs: N); | | |
| while While n <N do | | |
| \| | Sample Aₜ ~ p_{data}(Aₜ), Bₜ ~ p_{data}(Bₜ); | |
| \| | Compute loss L_{teach}(Aₜ, Bₜ;G_{A2B}, D_{Depth}) | |
| \| | using Eq. 7 and update G_{A2B}; | |
| \| | Compute loss L(D_{depth})(Aₜ, Bₜ;G_{A2B}) using | |
| \| | Eq.2 and update D_{Depth}; | |
| \| | Sample Aᵣ ~ p_{target}(Aᵣ); | |
| \| | Compute loss L_{student}(Aᵣ;G_{A2B}, G_{B2A}, | |
| \| | D_{RGB}) using Eq. 8 and update G_{A2B} and | |
| \| | G_{B2A}; | |
| \| | Compute loss L(D_{RGB})(Aᵣ;G_{A2B}, G_{B2A}) | |
| \| | using Eq.5 and update D_{RGB}; | |
| \| | if n >epoch decay teacher then | |
| \| | \| | α_{teach} * decay rate; |
| \| | else | |
| \| | \| | continue; |

As laid out in Algorithm 1, a 2-dimensional image is sampled, At, from pₜᵣₐᵢₙ(Aₜ) as input to generator 218. The output of generator 218 is the corresponding depth image, which is fed to discriminator 212 to be classified, as real or fake for example. Discriminator 212 is also trained with Bₜ as well as generated depth images Bₜ, using the loss described in Equation. 2. Apart from the adversarial loss, the training is facilitated with the help of pixel loss (Equation 3), in the form of Euclidean loss, for which a weighting parameter λₚᵢₓₑₗ is defined. After training teacher 210, a 2-dimensional image, Aᵣ, is sampled from the target 2-dimensional data, p_{target}(Aᵣ), which is fed to generator 218′ that is “shared” between the student and the teacher. In other words, generators 218 and 218′ are functionally equivalent, by sharing weightings or by being the same instance of a generator, for example. The depth images generated by generator 218′ are fed to discriminator 212 in the teacher network stream, thus providing a signal to generate realistic depth images. The synthesized depth image is also fed to the inverse generator 217 to transform the depth back to 2-dimensional using the loss expressed by Equation. 6. As noted above, this preserves identity information in the depth image while allowing for a more generalized mapping between 2-dimensional and depth to be learned through refinement of the original latent 2-dimensional-to-3D mapping. Discriminator 219, which can also follow a fully convolutional structure, is employed to provide an additional signal for the inverse generator to create realistic 2-dimensional images.

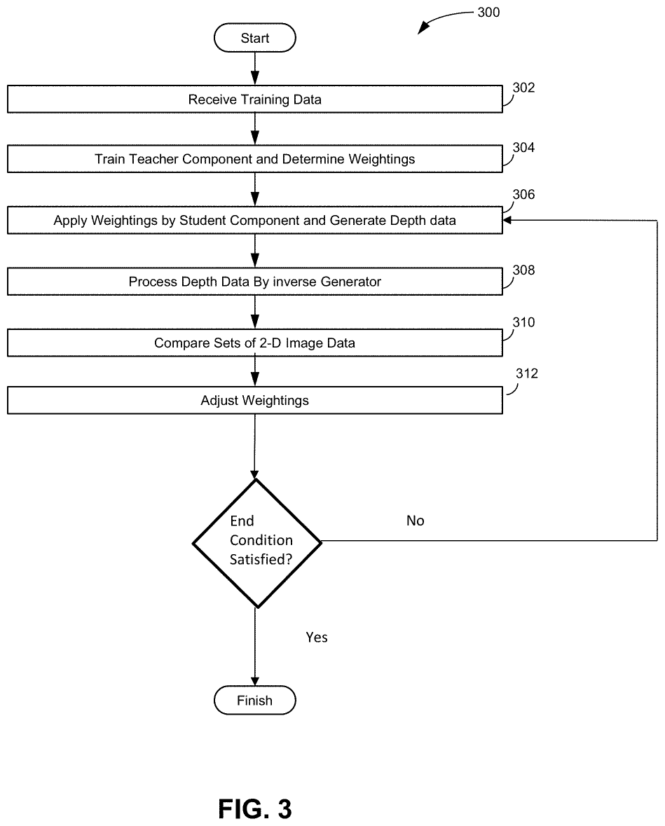

FIG. 3 is a flow chart of a method 300 in accordance with disclosed implementations. At 302, training data is received. The training data includes multiple sets of 2-dimensional image data and corresponding co-registered depth image data. At 304, the teacher component is trained, with the training data, to develop a set of mapping functions weightings for mapping between sets of 2-dimensional image data and corresponding co-registered depth image data and which can be applied to the student generator. At step 306, the mapping function weightings are applied, by the student generator, to a first set of 2-dimensional image data, to thereby generate synthesized depth data corresponding to the set of 2-dimensional image data. At 308, the synthesized depth data is processed, by the student inverse generator, to transform the depth data to a second set of 2-dimensional image data. At 310, the first set of 2-dimensional image data is compared to the second set of 2-dimensional image data and an error signal is generated based on the comparison. At 312, the set of mapping function weightings based on the error signal can be adjusted and, optionally, steps 306-312 can be repeated until the error represented by the error signal is less than a predetermined amount or any other end condition is satisfied. For example, the end condition can be a predetermined number of iterations or the like.

An example of specific implementation details is disclosed below. A fully convolutional structure can be used for the generator inspired, where an input image of size 128×128×3 is used to output a depth image with the same dimensions, as summarized in Table 1 below.

TABLE 1

| Module | Layer | Parameters |
|---|---|---|
| Residual | Input | 32 × 32 × 256 |
| block | Conv2d | Kernel 3 × 3, Feat. maps 256 |
| | | Stride 2, InstanceNorm, ReLU |
| | Conv2d | Kernel 3 × 3, Feat. maps 256 |
| | | Stride 2, InstanceNorm, ReLU |
| | Add (with input) | 32 × 32 × 256 |
| Generator | Image input | 128 × 128 × 3 |
| | Conv2d | Kernel 7 × 7, Feat. maps 64 |
| | | Stride 1, InstanceNorm, ReLU |
| | Conv2d | Kernel 3 × 3 Feat. maps 128 |
| | | Stride 2, InstanceNorm, ReLU |
| | Conv2d | Kernel 3 × 3, Feat. maps 256 |
| | | Stride 2, InstanceNorm, ReLU |
| | Residual block × 6 | Kernel 3 × 3, Feat. maps 256 |
| | | Stride 2, InstanceNorm, ReLU |
| | Conv2dTrans | Kernel 3 × 3, Feat. maps 128 |
| | | Stride 2, InstanceNorm, ReLU |
| | Conv2dTrans | Kernel 3 × 3, Feat. maps 64 |
| | | Stride 2, InstanceNorm, ReLU |
| | Conv2dTrans | Kernel 7 × 7, Feat. maps 3 |
| | | Stride 1, InstanceNorm, tanh |
| | Image out | 128 × 128 × 3 |
| Discrim- | Image input | 128 × 128 × 3 |
| inator | Conv2d | Kernel 4 × 4, Feat. maps 64 |
| | | Stride 2, InstanceNorm, LeakyReLU |
| | Conv2d | Kernel 4 × 4, Feat. maps 128 |
| | | Stride 2, InstanceNorm, LeakyReLU |
| | Conv2d | Kernel 4 × 4, Feat. maps 256 |
| | | Stride 2, InstanceNorm, LeakyReLU |
| | Conv2d | Kernel 4 × 4, Feat. maps 256 |
| | | Stride 2, InstanceNorm, LeakyReLU |
| | Conv2d | Kernel 4 × 4, Feat. maps 1 |
| | | Stride 1, InstanceNorm, LeakyReLU |
| | Discriminator Logits | 16 × 16 × 1 |

The encoder part of the generator contains three convolution layers with ReLU activation, where the number of feature maps is gradually increased (64, 128, 256) with a kernel size of 7×7 and a stride of 1 for the first layer. Subsequent layers use a kernel size of 3×3 and a stride of 2. This is followed by 6 residual blocks, consisting of 2 convolution layers, each with a kernel size of 3×3 and a stride of 2 and 256 feature maps as described in Table. The final decoder part of the generator follows a similar structure, with the exception of using de-convolution layers for upsampling instead of convolution, with decreasing feature maps (128, 64, 3). The last de-convolution layer which is used to map the features back to images uses a kernel size of 7×7 and a stride of 1, the same as the first layer of the encoder, but with a tan h activation.

A fully convolutional architecture can be used for the discriminator, with an input of size 128×128×3. The network uses 4 convolution layers, where the number of filters are gradually increased (64, 128, 256, 256), with a fixed kernel of 4×4 and a stride of 2. All the convolution layers use Instance normalization and leaky ReLU activations with a slope of 0.2. The final convolution layer uses the same parameters, with the exception of using only 1 feature map.

For stabilizing the model, the discriminators can be updated using images from a buffer pool of, for example, 50 generated images rather than the ones immediately produced by the generators. The network can be trained from scratch on an Nvidia GTX 2080Ti GPU, using TensorFlow 2.2. Adam optimizer and a batch size of 1 can be used. Additionally, two different learning rates of 0.0002 and 0.000002 can be used for the teacher and student components respectively. The learning can start decaying for the teacher on the 25th epoch with a decay rate 0.5, sooner than the student, where the learning rate decay can start after the 50th epoch. The weights λ_{eye} and λₚᵢₓₑₗ can be empirically determined to be 5 and 10, respectively.

Further, there are several well-known data sets that can be used for training. For example, the CurtinFaces, IIIT-D RGB-D, EURECOM KinectFaceDb, or Labeled Faces in-the-wild (LFW) data sets can be used. In the training phase of the research example, the entire CurtinFaces dataset was used to train the teacher in order to learn a strict latent mapping between RGB and depth. RGB and ground-truth depth images of this dataset were used as Aₜ and Bₜ respectively.

To train the student, we used the training subsets of the RGB images from IIIT-D RGB-D and EURECOM KinectFaceDb. IIIT-D TGB-D has a predefined protocol with a five-fold cross-validation strategy, which was strictly adhered to. For EURECOM KinectFaceDb, the data was divided in a 50-50 split between the training and testing sets, resulting in a total of 468 images in each set. In the case of the in-the-wild LFW RGB dataset, the whole dataset was used, setting aside 20 images from each of the 62 subjects for recognition experiments, amounting to 11,953 images.

For the testing phase, the trained generator was used to generate the hallucinated depth images for each RGB image available in the testing sets. then the RGB and depth images were used for training various recognition networks. For RGB-D datasets, we trained the recognition networks on the training sets using the RGB and hallucinated depth images and evaluated the performance on the testing sets. Concerning the LFW dataset, in the testing phase, we used the remaining 20 images from each of the 62 identities that are not used for training. We then used the output RGB and hallucinated depth images as inputs for the recognition experiment.

First, the quality of depth image generation was verified against other generators using pixel-wise quality assessment metrics. These metrics include pixel-wise absolute difference, L1 norm, L2 norm and Root Mean Squared Error (RMSE), with the aim of assessing the quality of the hallucinated depth by comparing them to the original co-registered ground depths. Also, a threshold metrics equation (δ) (Eq. 9), which measures the percentage of pixels under a certain error threshold was applied to provide a similarity score. The equation for this metric is expressed as follows:

$$\% of {y}_{i} s . t . max ( \frac{{y}_{i}}{{y}_{i}^{*}} , \frac{{y}_{i}^{*}}{{y}_{i}} ) = δ < val . , \qquad ( 9 )$$

where yᵢ and yᵢ*, respectively represent pixel values in ground truths and hallucinated depths, and val denotes the threshold error value which was set to 1.25.

The aim of the study was to use the hallucinated modality to boost recognition performance. As we wanted to present results with no dependency on a specific recognition architecture, we used a diverse set of standard deep networks, notably VGG-16, inception-v2, ResNet-50, and SE-ResNet-50, in the evaluation. The rank-1 identification results were reported with and without ground truth depth for RGB-D datasets as well as the results obtained by the combination of RGB and the hallucinated depth images. For LFW RGB datasets, we naturally did not have ground truth depths, so only the identification results were presented with and without the hallucinated depth. Also, different strategies were used, including feature-level fusion, score-level fusion, two-level attention fusion, and depth-guided attention, when combining RGB and depth images.

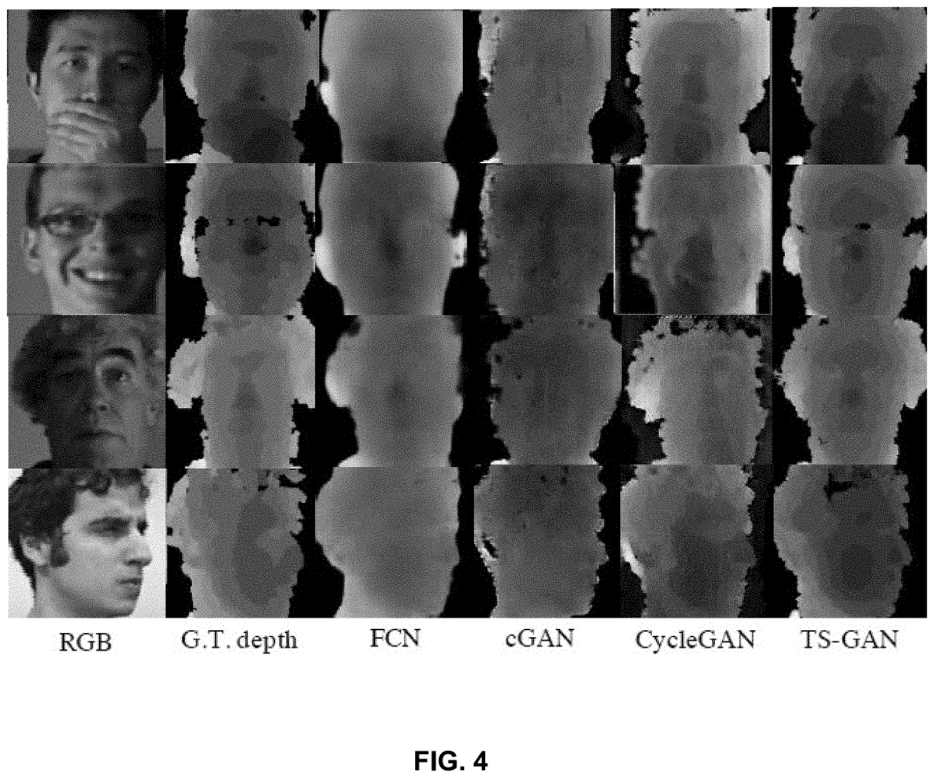

For quality assessment, the performance of TS-GAN was compared to alternative depth generators, namely Fully Convolutional Network (FCN), image-to-image translation cGAN, and CycleGAN. Experiments were performed on the CurtinFaces dataset, where 47 out of the 52 subjects were used for training the generator, and the remaining 5 subjects were used for generating depth images to be used for quality assessment experiments. FIG. 4 shows depth generated by the alternative methods as well as the TS-GAN implementation. It can be seen that the methods disclosed herein are able to generate realistic depth images which are very similar to the ground truth depth images.

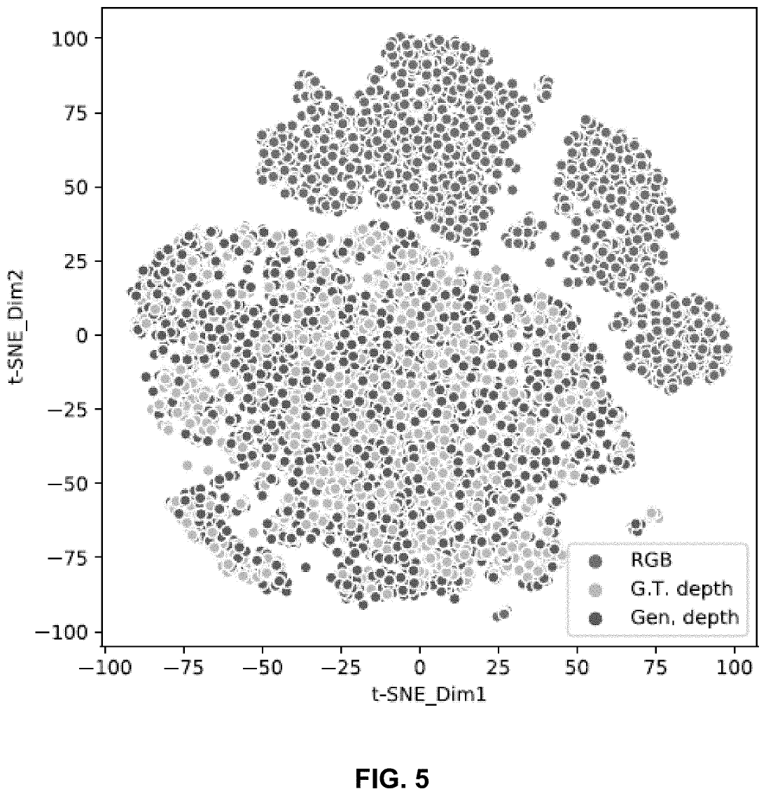

FIG. 5 shows a t-SNE visualization of the embeddings generated from a ResNet-50 network for RGB images, ground truth depth images, and hallucinated depth images by the disclosed methods. This visualization demonstrates a very high overlap between the ground truth and generated depth images, thus depicting their similarity.

Table 2 shows the results for pixel-wise objective metrics.

TABLE 2

| | FCN | cGAN | CycleGAN | Ours |
|---|---|---|---|---|
| Metrics | [4] | [34] | [24] | (TS-GAN) |
| Abs. Diff. ↓ | 0.0712 | 0.0903 | 0.1037 | 0.0754 |
| L1 Norm ↓ | 0.2248 | 0.2201 | 0.2387 | 0.2050 |
| L2 Norm ↓ | 89.12 | 89.05 | 90.32 | 82.54 |
| RMSE ↓ | 0.3475 | 0.3474 | 0.3542 | 0.3234 |
| δ(1.25) ↑ | 64.31 | 64.27 | 65.76 | 69.02 |
| δ(1.25²) ↑ | 81.66 | 82.08 | 82.56 | 87.20 |
| δ(1.25³) ↑ | 94.33 | 95.10 | 95.63 | 97.54 |

For the first four metrics including absolute difference, L1 Norm, L2 Norm, and RMSE, lower values indicate better image quality. It can be observed that the method disclosed herein consistently outperforms the other methods. The only exception is the absolute difference metric in which FCN shows slightly better performance. A potential reason for this observation is that FCN only uses one loss function that aims to minimize the absolute error between the ground truth and the generated depth, naturally resulting in minimal absolute difference error. For the threshold metric 6, higher percentage of pixels under the threshold error value of 1.25 represents better spatial accuracy for the image. The method disclosed herein achieves considerably better accuracy than other generators in terms of these metrics.

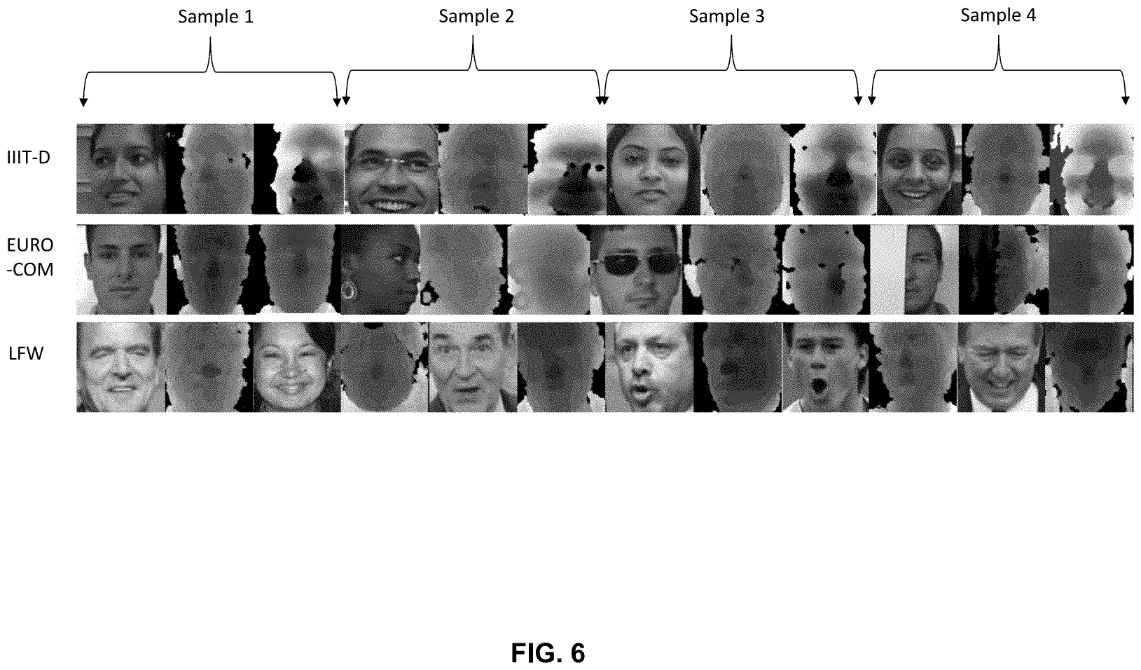

In order to show the generalization of the generator when applied to the other datasets for testing, resulting hallucinated depth samples for IIIT-D and EURECOM RGB-D datasets are shown in FIG. 6 (top and middle rows). In FIG. 6, for each of the four samples, the first and second columns show the input RGB images and the generated depth images, while the third column shows the ground truth depth image corresponding to the RGB image. As can be seen, the disclosed methods can adapt to different poses, expressions and occlusions present in the target datasets. The bottom row in this figure shows the depth generated for the in-the-wild LFW RGB dataset, where the disclosed method is able to adapt to the non-frontal and unnatural poses which are not present in the constrained, lab-acquired RGB-D datasets.

As noted above, rank-1 face identification results were used to demonstrate the effectiveness of the hallucinated depth for face recognition. In this context, the mapping function (Equation 1) was used to extract the corresponding depth image from the RGB image to be used as inputs to the recognition pipeline. Table 3 below shows the recognition results on the IIIT-D and KinectFaceDb datasets using the four networks discussed earlier.

| | | | HIT-D | EURECOM |
|---|---|---|---|---|
| Model | Input | Fusion | Acc. | Acc. |
| VGG-16 | RGB | — | 94.1% | 83.6% |
| | RGB + D | Feat. | 95.4% | 88.4% |
| | | Score | 94.4% | 84.5% |
| | RGB + \tilde{D} | Feat. | 95.4% | 88.3% |
| | | Score | 94.1% | 84.2% |
| Inception-v2 | RGB | — | 95.0% | 87.5% |
| | RGB + D | Feat. | 96.5% | 90.3% |
| | | Score | 95.0% | 86.9% |
| | RGB + \tilde{D} | Feat. | 96.1% | 90.1% |
| | | Score | 95.9% | 87.9% |
| ResNet-50 | RGB | — | 95.8% | 90.8% |
| | RGB + D | Feat. | 96.9% | 91.0% |
| | | Score | 95.9% | |
| | RGB + \tilde{D} | Feat. | 97.1% | 92.2% |
| | | Score | 96.1% | 90.7% |
| SE-ResNet-50 | RGB | — | 97.8% | 91.3% |
| | RGB + D | Feat. | 98.9% | 93.1% |
| | | Score | 97.9% | 91.6% |
| | RGB + \tilde{D} | Feat. | 98.6% | 93.2% |
| | | Score | 97.6% | 91.5% |
| Two-level att. | RGB + D | Feat.* | 99.4% | 92.0% |
| | RGB + \tilde{D} | Feat.* | 99.1% | 92.3% |
| Depth-guided att. | RGB + D | Feat.* | 99.7% | 93.1% |
| | RGB + \tilde{D} | Feat.* | 99.7% | 92.7% |

It can be observed that the fusion of RGB and the depth hallucinated using the disclosed TS-GAN consistently provides better results across all the CNN architectures, when compared to using solely the RGB images. For reference, recognition with RGB and the ground truth depth was also performed.

For the IIIT-D dataset, recognition with RGB and generated depth lead to comparable results to that with RGB and ground truth depth images. Concerning the EURECOM KinectFaceDb dataset, the results also show that the depth generated by the disclosed methods provide added value to the recognition pipeline as competitive results (slightly below) to that of RGB and ground truth depth are achieved. Interestingly, in some cases for both IIIT-D and KinectFaceDb, the hallucinated depths provided superior performance over the ground-truth depths. This is most likely due to the fact that some depth images available in the IIIT-D and KinectFaceDb datasets are noisy, while the disclosed generator can provide cleaner synthetic depth images as it has been trained on higher quality depth images available in the CurtinFaces dataset.

Table 4 below presents the recognition results on the in-the-wild LFW dataset, where the results are presented with and without our hallucinated depth images. It can be observed that the hallucinated depth generated by the disclosed examples significantly improves the recognition accuracy across all the CNN architectures, with 3.4%, 2.4%, 2.3%, 2.4% improvements for VGG-16, Inception-v2, ResNet-50, and SE-ResNet-50 respectively. The improvements are more obvious when considering the state-of-the-art attention-based methods, clearly indicating the benefits of our synthetic depth images to improve recognition accuracy.

TABLE 4

| Model | Input | Fusion | Accuracy |
|---|---|---|---|
| VGG-16 | RGB | — | 75.3% |
| | RGB + \tilde{D} | Feat. | 78.7% |
| | | Score | 76.1% |
| Inception-v2 | RGB | — | 78.1% |
| | RGB + \tilde{D} | Feat. | 80.5% |
| | | Score | 78.4% |
| ResNet-50 | RGB | — | 81.8% |
| | RGB + \tilde{D} | Feat. | 84.1% |
| | | Score | 81.7% |
| SE-ResNet-50 | RGB | — | 83.2% |
| | RGB + \tilde{D} | Feat. | 85.6% |
| | | Score | 83.2% |
| Two-level att. [43] | RGB + \tilde{D} | Feat.* | 84.7% |
| Depth-guided art [44] | RGB + \tilde{D} | Feat.* | 85.9% |

To evaluate the impact of each of the main components of the disclosed solution, ablation studies were performed by systematically removing the components. First, we removed the student component, resulting in the teacher. Next, we removed the discriminator from the teacher leaving only the A2B generator as discussed above. The results are presented in Table 5 and compared to our complete TSGAN solution. The presented recognition results are obtained using feature-level fusion scheme to combine RGB and hallucinated depth images. The results show that performance suffers by the removal of each component for all four CNN architectures, demonstrating the effectiveness of the disclosed approach.

TABLE 5

| | | IIIT-D | KinectFaceDb |
|---|---|---|---|
| Ablation Model | Classifier | Accuracy | Accuracy |
| Teacher | VGG-16 | 95.4% | 85.7% |
| | Inception-v2 | 95.0% | 88.6% |
| | ResNet-50 | 96.6% | 91.3% |
| | SE-ResNet-50 | 98.4% | 91.9% |
| Teacher's A2B Gen. | VGG-16 | 95.1% | 87.8% |
| | Inception-v2 | 96.0% | 88.2% |
| | ResNet-50 | 96.7% | 90.6% |
| | SE-ResNet-50 | 98.5% | 92.2% |
| Teacher-Student (TS-GAN) | VGG-16 | 95.4% | 88.3% |
| | Inception-v2 | 96.1% | 90.1% |
| | ResNet-50 | 97.1% | 92.2% |
| | SE-ResNet-50 | 98.6% | 93.2% |

The disclosed implementations teach a novel teacher-student adversarial architecture for depth generation from 2-dimensional images, such as RGB images. The disclosed implementations boost the performance of object recognition systems, such as facial recognition systems. The teacher component consisting of a generator and a discriminator learns a strict latent mapping between 2-dimensional data and depth image pairs following a supervised approach. The student, which itself consists of a generator-discriminator pair along with the generator shared with the teacher, then refines this mapping by learning a more generalized relationship between the 2-dimensional and depth domains for samples without corresponding co-registered depth images. Comprehensive experiments on three public face datasets show that the disclosed method and system outperformed other depth generation methods, both in terms of depth quality and face recognition performance.

The disclosed implementations can be implemented by various computing devices programmed with software and/or firmware to provide the disclosed functions and modules of executable code implemented by hardware. The software and/or firmware can be stored as executable code on one or more non-transient computer-readable media. The computing devices may be operatively linked via one or more electronic communication links. For example, such electronic communication links may be established, at least in part, via a network such as the Internet and/or other networks.

A given computing device may include one or more processors configured to execute computer program modules. The computer program modules may be configured to enable an expert or user associated with the given computing platform to interface with the system and/or external resources. By way of non-limiting example, the given computing platform may include one or more of a server, a desktop computer, a laptop computer, a handheld computer, a tablet computing platform, a Smartphone, a gaming console, and/or other computing platforms.

The various data and code can be stored in electronic storage devices which may comprise non-transitory storage media that electronically stores information. The electronic storage media of the electronic storage may include one or both of system storage that is provided integrally (i.e., substantially non-removable) with the computing devices and/or removable storage that is removably connectable to the computing devices via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media.

Processor(s) of the computing devices may be configured to provide information processing capabilities and may include one or more of a digital processor, an analog processor, a digital circuit designed to process information, an analog circuit designed to process information, a state machine, and/or other mechanisms for electronically processing information. As used herein, the term “module” may refer to any component or set of components that perform the functionality attributed to the module. This may include one or more physical processors during execution of processor readable instructions, the processor readable instructions, circuitry, hardware, storage media, or any other components.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method implemented by a neural network for determining mapping function weightings that are optimized for generating synthesized depth image data from 2-dimensional image data, the method comprising:
receiving training data, the training data including at least one set of 2-dimensional image data and corresponding co-registered depth image data;
training a first generator, with the training data, to develop a set of mapping functions weightings for mapping between sets of 2-dimensional image data and corresponding co-registered depth image data;
applying the mapping function weightings, by a second generator, to a first set of 2-dimensional image data, to thereby generate synthesized depth data corresponding to the set of 2-dimensional image data;
processing the synthesized depth data, by an inverse generator, to transform the depth data to a second set of 2-dimensional image data;
comparing the first set of 2-dimensional image data to the second set of 2-dimensional image data and generating an error signal based on the comparison;
adjusting the set of mapping function weightings based on the error signal; and
repeating the applying, processing comparing and adjusting steps until specified end criterion is satisfied.

2. The method of claim 1, wherein the neural network is a Teacher Student Generative Adversarial Network (TS-GAN) the TS-GAN including a teacher component consisting of the first generator as a teacher generator and a teacher discriminator, the TS-GAN also including a student component consisting of the second generator as a student generator, a student inverse generator, and a student discriminator, the student generator sharing a common set of weightings with the teacher generator.

3. The method of claim 1, wherein the first generator and the second generator are implemented as the same instance of a generator.

4. The method of claim 2, wherein the teacher generator and the student generator are implemented as separate instances of a generator that have the same set of mapping function weightings.

5. The method of claim 1, wherein the 2-dimensional image data is RGB image data.

6. The method of claim 1, wherein the 2-dimensional image data is facial data representing a face of a person.

7. The method of claim 1, wherein the 2-dimensional image data represents at least one of objects, vehicles, or machines on a roadway.

8. The method of claim 1, further comprising using the 2-dimensional image data and synthesized depth data for image recognition.

9. The method of claim 1, wherein the 2-dimensional image data and depth data are stored in a single file.

10. The method of claim 2, wherein a loss of the teacher discriminator is determined based on the following equation:
$$ℒ ( {D}_{depth} ) = \frac{1}{2} {𝔼}_{{B}_{t} ∼ {p}_{data} ( {B}_{t} )} [ {( {D}_{depth} ( {B}_{t} ) - 1 )}^{2} ] + \frac{1}{2} \text{?} [ ( {{D}_{depth} ( {G}_{A 2 B} ( {A}_{t} ) )}^{2} ] ,$$
$$\text{?} \text{indicates text missing or illegible when filed}$$
where: [symbol]
Bᵢ represents a depth image sampled from training data pₜᵣₐᵢₙ(Aₜ, Bₜ);
Aₜ represents a set of 2-dimensional image data;
Bₜ represents depth data corresponding to Aₜ; and
G_{A2B} is the mapping function.

11. The method of claim 2, wherein a Euclidean loss of the teacher discriminator is determined based on the following equation:
$${ℒ}_{pixel} = ( \frac{1}{n} ) {\sum }_{i = 1}^{n} \vert {B}_{t} - {G}_{A 2 B} ( {A}_{t} ) \vert .$$

12. The method of claim 2, wherein a loss of the student discriminator is determined based on the following equation:
$$ℒ ( {D}_{RGB} ) = \frac{1}{2} {𝔼}_{{A}_{r} ∼ {p}_{target} ( {A}_{r} )} [ {( {D}_{RGB} ( {A}_{r} ) - 1 )}^{2} ] + \frac{1}{2} {𝔼}_{{A}_{r} ∼ {p}_{target} ( {A}_{r} )} [ ( {{D}_{RGB} ( {G}_{B 2 A} ( {G}_{A 2 B} ( {A}_{r} ) ) )}^{2} ] .$$
where:
p_{target}(Aᵣ) represents the distribution of a 2-dimensional target data set; [symbol]
Aᵣ represents an image sampled from p_{target}(Aᵣ);
G_{A2B} is the mapping function; and
G_{B2A} is the inverse mapping function.

13. The method of claim 2, wherein at least one of the teacher generator, the student generator, and the student inverse generator comprise a convolutional neural network.

14. The method of claim 13, wherein the 2-dimensional image data and the synthesized depth data is of the size 128×128×3, and wherein an encoder portion of the student generator and an encoder portion of the teacher generator include the following structure:
3 convolution layers applying a rectified linear activation function (ReLU);
a quantity of feature maps is gradually increased from 64 to 128 to 256 with a kernel size of 7×7 and a stride of 1 for the first layer; and
subsequent layers use a kernel size of 3×3 and a stride of 2 followed by 6 residual blocks, consisting 2 convolution layers each with a kernel size of 3×3 and a stride of 2; and
a final decoder portion of the generator includes the following structure:
3 de-convolution layers for up-sampling applying a rectified linear activation function (ReLU);
a quantity of feature maps is gradually decreased from 128 to 64 to 3; and
a last de-convolution layer, which is used to map the features back to images, uses a kernel size of 7×7 and a stride of 1, with a tan h activation function.

15. The method of claim 1, where there are multiple iterations of the receiving, training, applying, processing, and adjusting steps.

16. A computing system implementing a neural network for determining mapping function weightings that are optimized for generating synthesized depth image data from 2-dimensional image data, the system comprising:
at least one hardware computer processor operative to execute computer-readable instructions; and
at least one non-transient memory device storing computer executable instructions thereon, which when executed by the at least one hardware computer processor, cause the at least one hardware computer processor to conduct a method of;
receiving training data, the training data including at least one set of 2-dimensional image data and corresponding co-registered depth image data;
training a first generator, with the training data, to develop a set of mapping functions weightings for mapping between sets of 2-dimensional image data and corresponding co-registered depth image data;
applying the mapping function weightings, by a second generator, to a first set of 2-dimensional image data, to thereby generate synthesized depth data corresponding to the set of 2-dimensional image data;
processing the synthesized depth data, by an inverse generator, to transform the depth data to a second set of 2-dimensional image data;
comparing the first set of 2-dimensional image data to the second set of 2-dimensional image data and generating an error signal based on the comparison;
adjusting the set of mapping function weightings based on the error signal; and
repeating the applying, processing comparing and adjusting steps until specified end criterion is satisfied.

17. The system of claim 16, wherein the neural network is a Teacher Student Generative Adversarial Network (TS-GAN) the TS-GAN including a teacher component consisting of the first generator as a teacher generator and a teacher discriminator, the TS-GAN also including a student component consisting of the second generator as a student generator, a student inverse generator, and a student discriminator, the student generator sharing a common set of weightings with the teacher generator.

18. The system of claim 16, wherein the teacher generator and the student generator are implemented as the same instance of a generator.

19. The system of claim 17, wherein the teacher generator and the student generator are implemented as separate instances of a generator that have the same set of mapping function weightings.

20. The system of claim 16, wherein the 2-dimensional image data is RGB image data.

21. The system of claim 16, wherein the 2-dimensional image data is facial data representing a face of a person.

22. The system of claim 16, wherein the 2-dimensional image data represents at least one of objects, vehicles, or machines on a roadway.

23. The system of claim 16, further comprising using the 2-dimensional image data and synthesized depth data for image recognition.

24. The system of claim 16, wherein the 2-dimensional image data and depth data are stored in a single file.

25. The system of claim 17, wherein a loss of the teacher discriminator is determined based on the following equation:
$$ℒ ( {D}_{depth} ) = \frac{1}{2} {𝔼}_{{B}_{t} ∼ {p}_{data} ( {B}_{t} )} [ {( {D}_{depth} ( {B}_{t} ) - 1 )}^{2} ] + \frac{1}{2} \text{?} [ ( {{D}_{depth} ( {G}_{A 2 B} ( {A}_{t} ) )}^{2} ] ,$$
$$\text{?} \text{indicates text missing or illegible when filed}$$
where: [symbol]
Bₜ represents a depth image sampled from training data;
Bₜ represents a set of 2-dimensional image data;
Aₜ represents depth data corresponding to Bₜ; and
G_{A2B} is the mapping function.

26. The method of claim 17, wherein a Euclidean loss of the teacher discriminator is determined based on the following equation:
$${ℒ}_{pixel} = ( \frac{1}{n} ) {\sum }_{i = 1}^{n} \vert {B}_{t} - {G}_{A 2 B} ( {A}_{t} ) \vert .$$

27. The method of claim 17, wherein a loss of the student discriminator is determined based on the following equation:
$$ℒ ( {D}_{RGB} ) = \frac{1}{2} {𝔼}_{{A}_{r} ∼ {p}_{target} ( {A}_{r} )} [ {( {D}_{RGB} ( {A}_{r} ) - 1 )}^{2} ] + \frac{1}{2} {𝔼}_{{A}_{r} ∼ {p}_{target} ( {A}_{r} )} [ ( {{D}_{RGB} ( {G}_{B 2 A} ( {G}_{A 2 B} ( {A}_{r} ) ) )}^{2} ] ,$$
where:
p_{target}(Aᵣ) represents the distribution of a 2-dimensional target data set; [symbol]
Aᵣ represents an image sampled from p_{target}(Aᵣ);
G_{A2B} is the mapping function; and
G_{B2A} is the inverse mapping function.

28. The method of claim 7, wherein at least one of the teacher generator, the student generator, and the student inverse generator comprise a convolutional neural network.

29. The method of claim 28, wherein the 2-dimensional image data and the synthesized depth data is of the size 128×128×3, and wherein an encoder portion of the student generator and an encoder portion of the teacher generator include the following structure:
3 convolution layers applying a rectified linear activation function (ReLU);
a quantity of feature maps is gradually increased from 64 to 128 to 256 with a kernel size of 7×7 and a stride of 1 for the first layer; and
subsequent layers use a kernel size of 3×3 and a stride of 2 followed by 6 residual blocks, consisting 2 convolution layers each with a kernel size of 3×3 and a stride of 2; and
a final decoder portion of the generator includes the following structure:
3 de-convolution layers for up-sampling applying a rectified linear activation function (ReLU);
a quantity of feature maps is gradually decreased from 128 to 64 to 3; and
a last de-convolution layer, which is used to map the features back to images, uses a kernel size of 7×7 and a stride of 1, with a tan h activation function.

30. The method of claim 1, where there are multiple iterations of the receiving, training, applying, processing, and adjusting steps.

31. Non-transient computer-readable media having computer-readable instructions stored thereon which, when executed by a computer processor cause the computer processor to conduct a method implemented by a neural network for determining mapping function weightings that are optimized for generating synthesized depth image data from 2-dimensional image data, the method comprising:
receiving training data, the training data including at least one set of 2-dimensional image data and corresponding co-registered depth image data;
training a first generator, with the training data, to develop a set of mapping functions weightings for mapping between sets of 2-dimensional image data and corresponding co-registered depth image data;
applying the mapping function weightings, by a second generator, to a first set of 2-dimensional image data, to thereby generate synthesized depth data corresponding to the set of 2-dimensional image data;
processing the synthesized depth data, by an inverse generator, to transform the depth data to a second set of 2-dimensional image data;
comparing the first set of 2-dimensional image data to the second set of 2-dimensional image data and generating an error signal based on the comparison;
adjusting the set of mapping function weightings based on the error signal; and
repeating the applying, processing comparing and adjusting steps until specified end criterion is satisfied.
